(19) United States
(12) Patent Application Publication
(10) Pub. No.: US 2009/0265462 A1
(43) Pub. Date: Oct. 22, 2009

(54) MONITORING APPARATUS AND STORAGE METHOD

(75) Inventor: Katsutoshi Tajiri, Inagi-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/426,094

(22) Filed: Apr. 17, 2009

(30) Foreign Application Priority Data
Apr. 18, 2008 (JP) 2008-109503

(51) Int. Cl. G06F 15/173; G06F 12/00; G06F 12/16

(52) U.S. Cl. 709/224; 711/161; 711/E12.001; 711/E12.103

(57) ABSTRACT

A monitoring apparatus receives information about a storage condition of monitoring data from a management apparatus via a network, and acquires at least one of image data and audio data as the monitoring data. The monitoring apparatus detects a communication state with the management apparatus, and performs control to store the monitoring data which is determined to satisfy the storage condition into a storage device that is other than the management apparatus according to the detected communication state.

### BACKGROUND OF THE INVENTION

1. Field of the Invention

The present invention relates to a monitoring apparatus that acquires at least one of image data and audio data as monitoring data, and a storage method that stores at least one of the image data and the audio data as the monitoring data.

2. Description of the Related Art

In recent years, a monitoring system using an Internet Protocol (IP) network such as the Internet has been increasingly used. For example, in monitoring a store or a building, images and/or audio of persons entering or exiting during a certain period of time or when sensor detection occurs, are stored. The stored data is viewed and checked by an administrator if the need arises. As a specific example, a monitoring system using a network system has been used.

In such a monitoring system, there are two major methods for storing image data and/or audio data. In the first storage method, a monitoring camera has a storage schedule, and stores image data and/or audio data according to the schedule. Then, a remote management device acquires the stored data in the monitoring camera at an appropriate timing. In the second storage method, a remote management device has a storage schedule. According to the storage schedule, the remote management device acquires image data and/or audio data from a monitoring camera, and stores the data.

As conventional art on storing image data and/or audio data, there are Japanese Patent Application Laid-Open No. 2006-19844 and Japanese Patent Application Laid-Open No. 2003-274383. More specifically, Japanese Patent Application Laid-Open No. 2006-19844 discusses a method for acquiring images in a captured order using retransmission means even if a network failure occurs. Japanese Patent Application Laid-Open No. 2003-274383 discusses a method for using the same communication protocol which a client uses, among a video delivery server, a storage server, and a storage schedule management server.

However, in the above-described first storage method in which the monitoring camera has the storage schedule, the monitoring camera always stores the image data and/or the audio data therein. Accordingly, for example, if a power supply is shut off while the data is being stored, the data that has not been acquired by the management device may be lost.

Further, in the above-described second storage method by which the remote management device has the storage schedule, if a network failure occurs or the remote management device is suspended for some reason, even if the monitoring camera is in operation, it may not be possible to store the image data and/or the audio data.

That is, if a system failure such as the shutoff of a power supply or a network failure occurs, it may be difficult using conventional techniques to dependably store the monitoring data such as the image data and/or the audio data.

### SUMMARY OF THE INVENTION

Aspects of the present invention are directed to a monitoring apparatus that can more dependably acquire monitoring data, and a storage method that can store the monitoring data.

According to an aspect of the present invention, a monitoring apparatus that acquires at least one of image data and audio data as monitoring data is provided. The monitoring apparatus includes a reception unit configured to receive information about a storage condition of the monitoring data from a management apparatus via a network, a detection unit configured to detect a communication state with the management apparatus, and a control unit configured to perform control to store the monitoring data which is determined to satisfy the storage condition into a storage device that is other than the management apparatus according to the communication state detected by the detection unit.

According to another aspect of the present invention, a method of storing at least one of image data and audio data as monitoring data is provided. The method includes transferring information about a storage condition of the monitoring data from a management apparatus to a monitoring apparatus via a network, detecting a communication state between the management apparatus and the monitoring apparatus, and performing control to store the monitoring data which is determined to satisfy the storage condition into a storage device that is other than the management apparatus according to the detected communication state.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute apart of the specification, illustrate exemplary embodiments, features, and aspects of the invention and, together with the description, serve to explain principles of the invention.

FIG. 1 illustrates an example of a schematic configuration of a monitoring system (data storage system) according to an exemplary embodiment of the present invention.

FIG. 2 is a block diagram illustrating an example of an internal configuration of a monitoring camera illustrated in FIG. 1.

FIG. 3 is a block diagram illustrating an example of an internal configuration of a remote management device illustrated in FIG. 1.

FIG. 4 is a schematic view illustrating an example of various programs and various kinds of data (information) which are stored in a primary storage device and a secondary storage device in the monitoring camera illustrated in FIG. 2.

FIG. 5 is a schematic view illustrating an example of various programs and various kinds of data (information) which are stored in a primary storage device and a secondary storage device in the remote management device illustrated in FIG. 3.

FIG. 6 is a flowchart illustrating an example of a procedure in a control method executed by the monitoring camera using a storage implementation program illustrated in FIG. 1.

FIG. 7 is a flowchart illustrating an example of a procedure in a control method executed by the remote management device using a storage implementation program illustrated in FIG. 1.

FIG. 8 is a flowchart illustrating an example of a procedure in a control method executed by the monitoring camera using a storage data management program illustrated in FIG. 1.

FIG. 9 is a flowchart illustrating an example of a procedure in a control method executed by the remote management device using a storage data management program illustrated in FIG. 1.

### DETAILED DESCRIPTION OF THE EMBODIMENTS

Various exemplary embodiments, features, and aspects of the invention will be described in detail below with reference to the drawings.

In an exemplary embodiment of the present invention, a monitoring system using a network is described as an example of a data storage system, and image data is used as an example of monitoring data. However, audio data may also be used as the monitoring data. In such a case, a delivery and storage algorithm for the audio data may be the same as an algorithm for the image data except for the content. Accordingly, the delivery and storage algorism can be similarly used for the audio data.

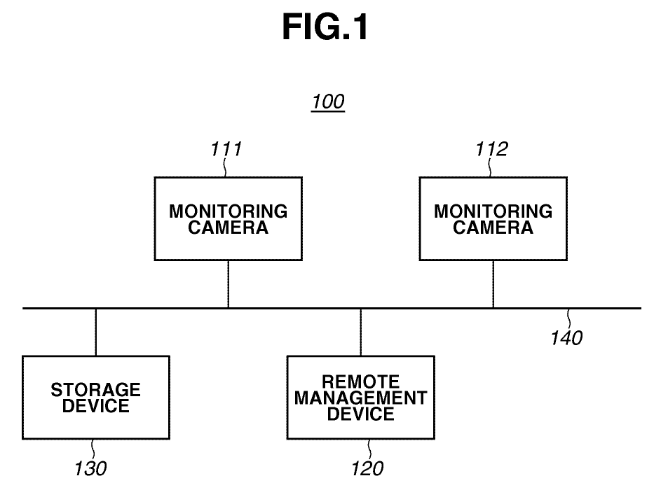

FIG. 1 illustrates an example of a schematic configuration of a monitoring system (i.e., data storage system) according to the present exemplary embodiment of the present invention.

A monitoring system 100 illustrated in FIG. 1 includes monitoring cameras 111 and 112, a remote management device 120, and a storage device 130 which are communicably connected to each other by a network 140.

The monitoring cameras 111 and 112 are monitoring apparatus that acquire at least one of image data and audio data. In the present exemplary embodiment, the monitoring cameras 111 and 112 mainly acquire the image data as the monitoring data. Each of the monitoring cameras 111 and 112 includes at least one of a camera that can change a shooting angle and a camera that has a fixed angle of view. The monitoring cameras 111 and 112 can deliver (send) the image data obtained by shooting, via the network 140. The monitoring cameras 111 and 112 can individually operate. In FIG. 1, to simplify the description, a number of the monitoring cameras is two. However, three or more monitoring cameras may also be used.

The remote management device 120 stores and manages the monitoring data (e.g., image data). For example, the remote management device 120 accesses each of the monitoring cameras 111 and 112, acquires and manages the image data of a live image or the image data of a stored image.

The storage device 130 may be provided separately from the remote management device 120. The storage device 130 communicates with the monitoring cameras 111 and 112 as needed, and receives and stores the monitoring data (e.g., image data).

The network 140 is a communication medium including, for example, a plurality of routers, switches and cables that are compliant with a communication standard such as Ethernet. The network 140 in the present exemplary embodiment has no limitation on the communication standard, scale, and configuration as long as communication between each server and client can be performed with relatively no difficulty. Accordingly, as the network 140, for example, the Internet as well as a local area network (LAN) may be used.

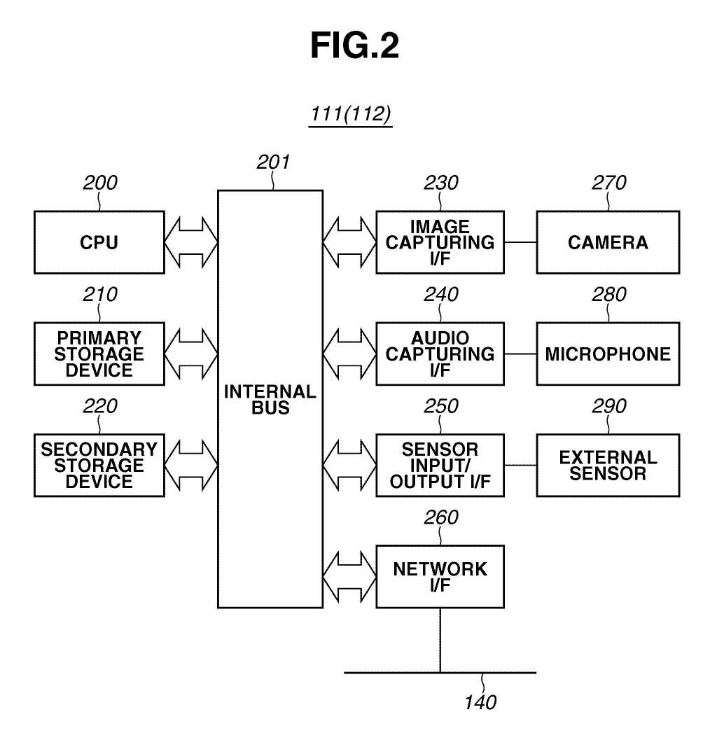

FIG. 2 is a block diagram illustrating an example of an internal configuration of the monitoring camera 111 (or the monitoring camera 112) illustrated in FIG. 1.

The monitoring camera 111 (or the monitoring camera 112) includes an internal bus 201 in the camera. The monitoring camera 111 (or the monitoring camera 112) includes a central processing unit (CPU) 200, a primary storage device 210, a secondary storage device 220, and various interfaces (I/F) 230 to 260 that are connected to the internal bus 201. More specifically, the monitoring camera 111 (or the monitoring camera 112) includes the various interfaces such as an image capturing I/F 230, an audio capturing I/F 240, a sensor input/output I/F 250, and a network I/F 260. Further, the monitoring camera 111 (or the monitoring camera 112) includes a camera 270 connected to the image capturing I/F 230, a microphone 280 connected to the audio capturing I/F 240, and an external sensor 290 connected to the sensor input/output I/F 250.

The CPU 200 controls an overall operation in the monitoring camera.

The primary storage device 210 is, for example, a writable high-speed storage device such as a random access memory (RAM). In the primary storage device 210, for example, an operating system (OS), various programs, and various kinds of data are loaded. Further, the primary storage device 210 is used as a work area when the CPU 200 implements the OS, the various programs, or the like.

The secondary storage device 220 is a nonvolatile storage device such as a floppy disk drive (FDD), a hard disk drive (HDD), a flash memory, a compact disk read only memory (CD-ROM) drive, or the like. The secondary storage device 220 is used as a permanent storage area for the OS, the various programs, and the various kinds of data, and also used as a temporary storage area for the various kinds of data, or the like.

The image capturing I/F 230 converts and compresses image data of an image captured by the connected camera 270 into a predetermined format, and transfers the data to, for example, the primary storage device 210.

The audio capturing I/F 240 converts and compresses audio data of audio collected by the microphone 280 into a predetermined format, and transfers the data to, for example, the primary storage device 210.

The sensor input/output I/F 250 notifies the program in the primary storage device 210 of a detection signal detected by the external sensor 290 connected thereto. More specifically, the sensor input/output I/F 250 sends the detection signal detected by the external sensor 290 to the CPU 200. Accordingly, the CPU 200 can use the detection signal in the processing using the program in the primary storage device 210. Based on an instruction issued from the program in the primary storage device 210 which is processed by the CPU 200, the sensor input/output I/F 250 controls an output signal of the external sensor 290.

The network I/F 260 connects to the network 140 in FIG. 1, and communicates with the remote management device 120, or the like via the network 140.

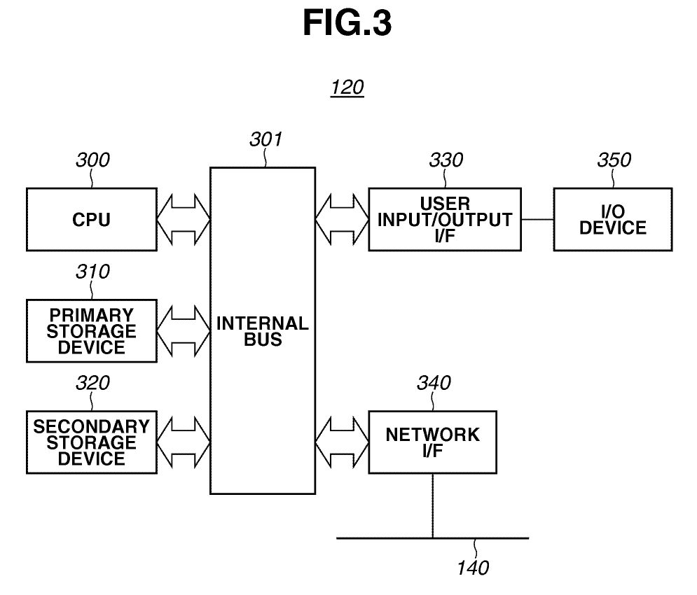

FIG. 3 is a block diagram illustrating an example of an internal configuration of the remote management device 120 illustrated in FIG. 1. The remote management device 120 includes an internal bus 301 in the device. The remote management device 120 includes a CPU 300, a primary storage device 310, a secondary storage device 320, a user input/output I/F 330, and a network I/F 340 that are connected to the internal bus 301. The remote management device 120 further includes an input/output (I/O) device 350 connected to the user input/output I/F 330.

The CPU 300 controls an overall operation in the remote management device 120.

The primary storage device 310 is, for example, a writable high-speed storage device such as a RAM. In the primary storage device 310, for example, an OS, various programs, and various kinds of data are loaded. Further, the primary storage device 310 is used as a work area when the CPU 300 implements the OS, the various programs, or the like.

The secondary storage device 320 is, for example, a nonvolatile storage device such as a FDD, a HDD, a flash memory, a CD-ROM drive, or the like. The secondary storage device 320 is used as a permanent storage area for the OS, the various programs, and the various kinds of data, and also used as a temporary storage area for the various kinds of data, or the like.

The user input/output I/F 330 controls input and output from/to a user via the connected I/O device 350.

The network I/F 340 connects to the network 140 in FIG. 1, and communicates with the monitoring cameras 111, 112, or the like via the network 140.

The I/O device 350 includes, for example, a keyboard, a mouse, or a display.

Next, the various programs and the various kinds of data (information) stored in the primary storage device 210 and the secondary storage device 220 in the monitoring camera 111 (or the monitoring camera 112) will be described.

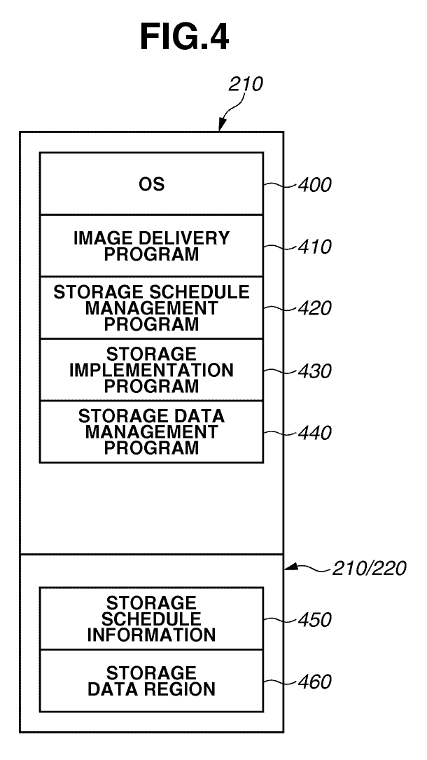

FIG. 4 is a schematic view illustrating an example of the various programs and the various kinds of data (information) stored in the primary storage device 210 and the secondary storage device 220 in the monitoring camera 111 (or the monitoring camera 112) illustrated in FIG. 2. Locations (e.g., addresses) and sizes of the various programs in the storage device are managed by an OS 400.

As illustrated in FIG. 4, the OS 400, an image delivery program 410, a storage schedule management program 420, a storage implementation program 430, and a storage data management program 440 are loaded in the primary storage device 210 in the present exemplary embodiment. In the primary storage device 210 and the secondary storage device 220, storage schedule information 450 and a storage data region 460 are stored. It is not necessary to store the storage schedule information 450 and the storage data region 460 in the monitoring camera 111 or 112. Depending on circumstances, the storage schedule information 450 and the storage data region 460 may also be stored in, for example, the storage device 130 connected to the network 140 using a function of the OS 400.

The OS 400 is a basic program for controlling the entire monitoring camera. The OS 400 also manages time information in the monitoring camera.

The image delivery program 410 performs processing to deliver image data (i.e., monitoring data) of an image captured by the camera 270 in response to a request from various clients.

The storage schedule management program 420 performs processing to receive storage schedule information from the remote management device 120, and store the information as the storage schedule information 450. The storage schedule information 450 corresponds to storage condition information that indicates a storage condition of the monitoring data (e.g., image data) in the remote management device 120.

The storage schedule information 450 includes storage scheduling information indicating a period of time in which the monitoring data can be stored, storage event information that triggers storage of the monitoring data, and storage time information indicating the storage time of the monitoring data when a storage event occurs. More specifically, the storage scheduling information includes storage start time and storage finish time for permitting the storage as the period of time in which the monitoring data can be stored. The storage time information indicates how long storage of the monitoring data continues when the storage event occurs. In the primary storage device 210 or the secondary storage device 220, a plurality of pairs of the storage schedule information 450 which includes the storage scheduling information, the storage event information, and the storage time information is stored.

As the storage event, for example, a timer event in predetermined intervals using a timer function of the OS 400, or an image event by recognition of a specified object or object motion detection in image data of an image captured by the camera 270 may be applied. Further, as the storage event, for example, an audio event by detection of audio which is input at a predetermined volume level from the microphone 280, or a sensor event by detection (e.g., signal detection) of change in a signal detected by the external sensor 290 may be applied.

In the present exemplary embodiment, as the storage event for storing the monitoring data, at least one of the above-described timer event, image event, audio event, and sensor event can be applied.

The storage implementation program 430 performs implementation processing for storage of the monitoring data according to the storage condition indicated in the storage schedule information 450.

More specifically, in the storage implementation program 430, current time information is acquired from the OS 400. When time in the current time information is within a period from the storage start time to the storage finish time defined in the storage scheduling information, the storage event is in a waiting state.

When the storage event occurs, the storage implementation program 430 performs processing to detect a communication state with the remote management device 120. When communication is established with the remote management device 120 (that is, when it is possible to communicate with the remote management device 120), the storage implementation program 430 performs processing to permit the remote management device 120 to store the monitoring data.

On the other hand, when the communication is not established with the remote management device 120 (that is, when it is not possible to communicate with the remote management device 120), the storage implementation program 430 performs processing to store the monitoring data in a storage device other than the remote management device 120. In such a case, for example, the monitoring data is stored in the storage data region 460 in the primary storage device 210 or the secondary storage device 220 provided in the monitoring camera as illustrated in FIG. 4. In the present exemplary embodiment, when the communication with the remote management device 120 is not established, the monitoring data may also be stored in another storage device 130 via the network 140.

The storage data management program 440 performs processing to manage the monitoring data (e.g., storage monitoring data) stored in the storage data region 460.

More specifically, the storage data management program 440 performs processing to store the image data of the image captured by the camera 270 into the storage data region 460 and updates storage information according to an instruction by the storage implementation program 430. The storage information is management information about the storage monitoring data existing in the storage data region 460.

Further, when a request to check whether the storage monitoring data exists is received from the remote management device 120, the storage data management program 440 performs processing to notify the remote management device 120 of contents of the managed storage information. Depending on circumstances, when the monitoring data is stored in the monitoring camera or the storage device 130, the storage data management program 440 may perform processing to regularly notify the remote management device 120 of the existence of the storage monitoring data at predetermined intervals based on the storage information. By the above-described processing, the storage data management program 440 can prompt the remote management device 120 to acquire the storage monitoring data immediately after restoration of a system failure.

Further, when a request to delete the storage monitoring data is received from the remote management device 120, the storage data management program 440 performs processing to delete the storage monitoring data from the storage data region 460 and update the storage information according to the deletion request.

Next, the various programs and the various kinds of data (information) stored in the primary storage device 310 and the secondary storage device 320 in the remote management device 120 will be described.

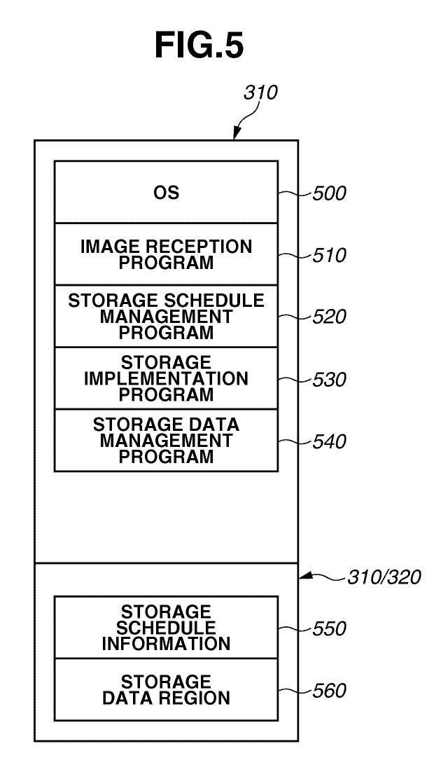

FIG. 5 is a schematic view illustrating an example of the various programs and the various kinds of data (information) stored in the primary storage device 310 and the secondary storage device 320 in the remote management device 120 illustrated in FIG. 3. Locations (e.g., addresses) and sizes of the various programs in the storage device are managed by an OS 500.

As illustrated in FIG. 5, in the present exemplary embodiment, the OS 500, an image reception program 510, a storage schedule management program 520, a storage implementation program 530, and a storage data management program 540 are loaded into the primary storage device 310. In the primary storage device 310 and the secondary storage device 320, storage schedule information 550 and a storage data region 560 are stored. It is not necessary to store the storage schedule information 550 and the storage data region 560 in the remote management device 120. Depending on circumstances, the storage schedule information 550 and the storage data region 560 may be stored in, for example, the storage device 130 connected to the network 140 using a function of the OS 500.

The OS 500 is a basic program for controlling the entire remote management device 120. The OS 500 also manages time information in the remote management device 120.

The image reception program 510 performs processing to send a request to transmit image data of a current live image or image data of a storage image to the monitoring cameras 111 and 112, and receive the image data (i.e., monitoring data) as a response to the request. Further, if necessary, the image reception program 510 performs processing to display the received image data on a display or store the received image data in the storage data region 560.

The storage schedule management program 520, when a user sets a storage schedule, a storage event, and storage time via the I/O device 350, performs processing to store and manage the information as a pair of storage schedule information 550. At the same time, the storage schedule management program 520 performs processing to send the storage schedule information 550 to the storage schedule management program 420 in the monitoring camera 111 (or the monitoring camera 112). By the above-described processing, the monitoring camera 111 (or the monitoring camera 112) receives the storage schedule information 550 from the remote management device 120 and stores the information as the storage schedule information 450.

When the storage schedule information 550 is sent from the remote management device 120, a data format for sending the information via the network 140 need not be of same as the storage schedule information 550.

The storage schedule information 550 includes storage scheduling information indicating a period of time in which the monitoring data can be stored, storage event information that triggers storage of the monitoring data, and storage time information indicating the storage time of the monitoring data when a storage event occurs. More specifically, the storage scheduling information includes storage start time and storage finish time for permitting the storage as the period of time in which the monitoring data can be stored. The storage time information indicates how long the storage of the monitoring data continues when the storage event occurs. In the primary storage device 310 or the secondary storage device 320, a plurality of pairs of the storage schedule information 550 which includes the storage scheduling information, the storage event information, and the storage time information is stored.

As the storage event, for example, a timer event in predetermined intervals using a timer function of the OS 500, or an image event by recognition of a specified object or object motion detection in the image data received from the monitoring camera 111 or the 112 may be applied. Further, as the storage event, for example, an audio event by detection of audio at a predetermined volume level of audio data received from the monitoring camera 111 or 112, or a sensor event by a sensor detection notification from the monitoring camera 111 or 112 may be applied.

In the present exemplary embodiment, as described above, at least one of the above-described timer event, image event, audio event, and sensor event can be applied as the storage event for storing the monitoring data.

The storage implementation program 530 performs implementation processing for storage of the monitoring data according to the storage condition indicated in the storage schedule information 550.

More specifically, in the storage implementation program 530, current time information is acquired from the OS 500. When time in the current time information is within a period from the storage start time to the storage finish time defined in the storage scheduling information, the storage event is in a waiting state.

When the storage event occurs, the storage implementation program 530 performs processing to store the monitoring data (image data) received before and after the event, into the storage data region 560.

The storage data management program 540 performs processing to manage the monitoring data (i.e., storage monitoring data) stored in the storage data region 560.

More specifically, the storage data management program 540 performs processing to store the image data received from the monitoring camera 111 or 112 in the storage data region 560 and updates storage information according to an instruction by the storage implementation program 530. The storage information is management information about the storage monitoring data existing in the storage data region 560.

Further, the storage data management program 540 performs processing to display the storage monitoring data (e.g., storage image data) required by the user via the I/O device 350 on the display. Further, the storage data management program 540 performs processing to delete the monitoring data from the storage data region 560 and update the storage information according to an instruction to delete the storage monitoring data by the user inputted via the I/O device 350.

Next, a procedure in a method for controlling the monitoring camera 111 (or the monitoring camera 112), and the remote management device 120 are described.

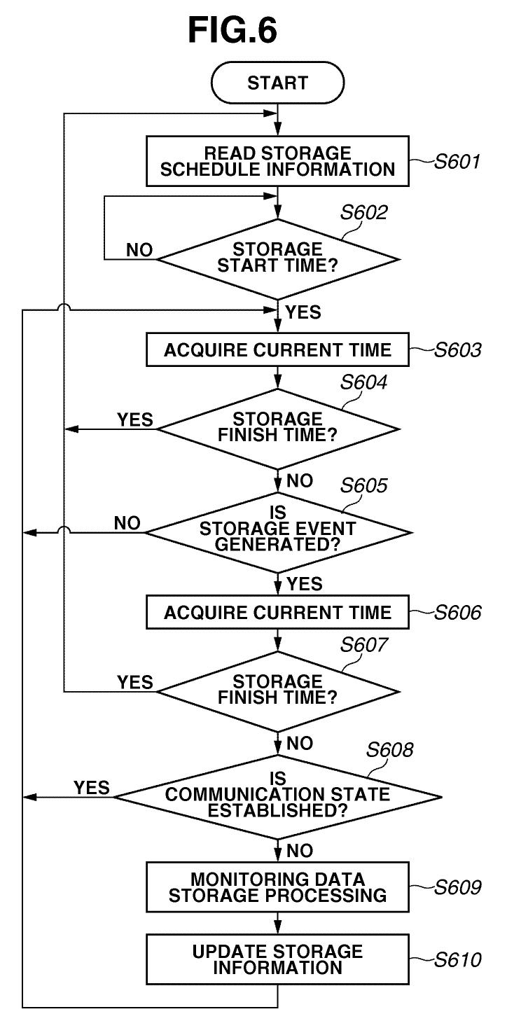

FIG. 6 is a flowchart illustrating an example of the procedure in a method for controlling the monitoring camera 111 (or the monitoring camera 112) illustrated in FIG. 1 using the storage implementation program 430. The processing illustrated in FIG. 6 is performed, for example, by the CPU 200 in the monitoring camera 111 (or the monitoring camera 112) executing the storage implementation program 430.

When the storage implementation program 430 is started, the CPU 200 receives the storage schedule information 550 from the remote management device 120. The received information is stored in the primary storage device 210 or the secondary storage device 220 as the storage schedule information 450. In step S601, the CPU 200 reads the storage schedule information 450.

In step S602, the CPU 200 waits until current time of the monitoring camera reaches the storage start time in the storage scheduling information in the storage schedule information 450.

When the current time of the monitoring camera reaches the storage start time in the storage schedule information 450 (YES in step S602), the processing proceeds to step S603. If the storage start time has not been reached (NO in step S602), step S602 is repeated. In step S603, the CPU 200 acquires the current time again.

In step S604, the CPU 200 determines whether the current time acquired in step S603 has reached the storage finish time in the storage scheduling information in the storage schedule information 450. As a result of the determination, when the current time acquired in step S603 has reached the storage finish time (YES in step S604), the processing returns to step S601.

When the current time acquired in step S603 has not reached the storage finish time (NO in step S604), the processing proceeds to step S605. In step S605, the CPU 200 waits until a storage event indicated in the storage event information in the storage schedule information 450 occurs.

When the storage event indicated in the storage event information in the storage schedule information 450 occurs (YES in step S605), the processing proceeds to step S606. In the present exemplary embodiment, when one of the above-described timer event, image event, audio event, and sensor event occurs, the processing proceeds to step S606. In step S606, the CPU 200 acquires the current time again. If the storage event has not occurred (NO in step S605), processing returns to step S603.

In step S607, the CPU 200 determines whether the current time acquired in step S606 has reached the storage finish time in the storage scheduling information in the storage schedule information 450. As a result of the determination, when the current time acquired in step S606 has reached the storage finish time (YES in step S607), the processing returns to step S601.

When the current time acquired in step S606 has not reached the storage finish time (NO in step S607), the processing proceeds to step S608. In other words, the processing proceeds to step S608 when the storage condition for the monitoring data indicated in the storage schedule information 450 is satisfied in the monitoring camera.

In step S608, the CPU 200 detects a communication state with the remote management device 120 according to processing by the image delivery program 410. Based on the detection, the CPU 200 determines whether the communication state with the remote management device 120 (that is, whether it is possible to communicate with the remote management device 120) is established.

As a result of the determination, when the communication state with the remote management device 120 is established (for example, it is in a state that the monitoring data when the storage event occurs is delivered to the remote management device 120) (YES in step S608), it may not be necessary for the monitoring data at the current time to be stored in the own device. Accordingly, the processing returns to step S603.

On the other hand, when the communication state is not established with the remote management device 120 (that is, it is not possible to communicate with the remote management device 120) (NO in step S608), the processing proceeds to step S609. The state in which it is not possible to communicate with the remote management device 120 includes, for example, a case where the remote management device 120 is not in operation, a case where it is not possible to access the remote management device 120 via the network 140, or the like. That is, the state in which it is not possible to communicate with the remote management device 120 is a state in which it is not possible to communicate with the remote management device 120 due to a factor other than the monitoring device.

In step S608, for example, when the storage event occurs during image capturing of the image data and the image data is not being sent to the remote management device 120, it is determined that a system failure is occurring with the remote management device 120 and the communication state is not established.

In step S609, the CPU 200 performs control to store the image data, namely the monitoring data into the storage data region 460 in the primary storage device 210 or the secondary storage device 220 for the storage time indicated in the storage time information in the storage schedule information 450. The CPU 200 may also perform control to store the monitoring data in the other storage device 130 via the network 140 instead of the primary storage device 210 or the secondary storage device 220 in the device itself.

In step S610, the CPU 200 performs processing to update the storage information about the storage monitoring data existing in the storage data region 460. Then, the processing returns to step S603.

Since the monitoring camera 111 (or the monitoring camera 112) and the remote management device 120 are physically different from each other, the time information managed in each device is not always the same. Accordingly, the storage processing of the monitoring data in step S609 may be performed by considering following points.

The monitoring data is stored in the storage device by considering an error between the time information in the monitoring camera 111 (or the monitoring camera 112) and that in the remote management device 120. More specifically, when the monitoring data is stored in the storage device, the CPU 200 performs control to put the storage start time of the monitoring data ahead a certain period of time, and delay the storage finish time thereof for a certain period of time. In the CPU 200, the time error between the devices is measured, and the storage start time and the storage finish time may be adjusted by considering the error value.

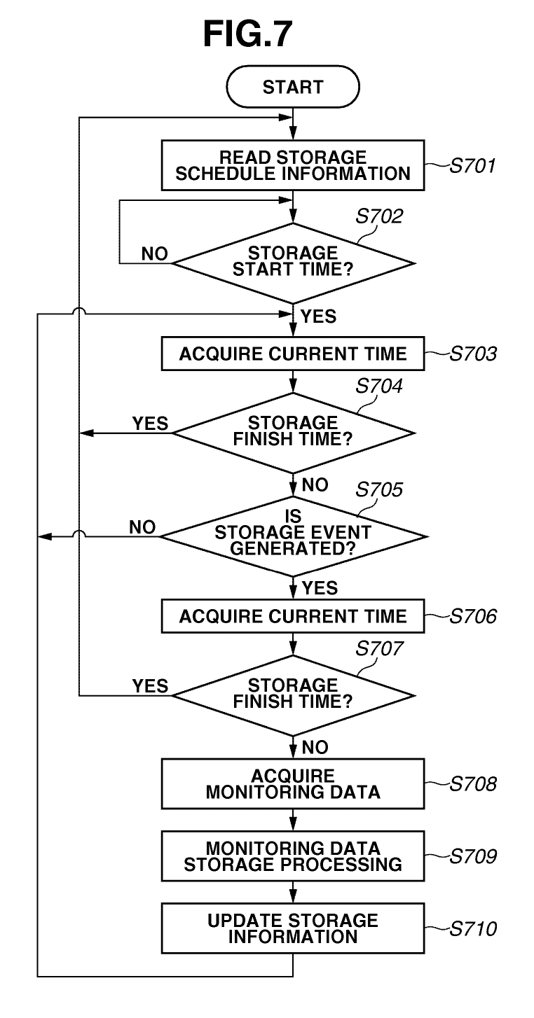

FIG. 7 is a flowchart illustrating an example of the procedure in a method for controlling the remote management device 120 illustrated in FIG. 1 using the storage implementation program 530. The processing illustrated in FIG. 7 is performed, for example, by the CPU 300 in the remote management device 120 executing the storage implementation program 530.

When the storage implementation program 530 is started, in step S701, the CPU 300 reads the storage schedule information 550 set by the user from the primary storage device 310 or the secondary storage device 320.

In step S702, the CPU 300 waits until current time of the remote management device 120 reaches the storage start time in the storage scheduling information in the storage schedule information 550.

When the current time of the remote management device 120 reaches the storage start time in the storage schedule information 550 (YES in step S702), the processing proceeds to step S703. In step S703, the CPU 300 acquires the current time again. If the storage start time has not been reached (NO in step S702), step S702 is repeated.

In step S704, the CPU 300 determines whether the current time acquired in step S703 has reached the storage finish time in the storage scheduling information in the storage schedule information 550. As a result of the determination, when the current time acquired in step S703 has reached the storage finish time (YES in step S704), the processing returns to step S701.

When the current time acquired in step S703 has not reached the storage finish time (NO in step S704), the processing proceeds to step S705. In step S705, the CPU 300 waits until the storage event indicated in the storage event information in the storage schedule information 550 occurs. In step S608 in FIG. 6, if the communication state is established, the monitoring camera 111 (or the monitoring camera 112) delivers the monitoring data when the storage event occurs as the storage event, to the remote management device 120.

When the storage event indicated in the storage event information in the storage schedule information 550 occurs (YES in step S705), the processing proceeds to step S706. In the present exemplary embodiment, when one of the above-described timer event, image event, audio event, and sensor event occurs, the processing proceeds to step S706. In step S706, the CPU 300 acquires the current time again. If the storage event has not occurred (NO in step S705), processing returns to step S703.

In step S707, the CPU 300 determines whether the current time acquired in step S706 has reached the storage finish time in the storage scheduling information in the storage schedule information 550. As a result of the determination, if the current time acquired in step S706 has reached the storage finish time (YES in step S707), the processing returns to step S701.

If the current time acquired in step S706 has not reached the storage finish time (NO in step S707), the processing proceeds to step S708. In other words, the processing proceeds to step S708 when the storage condition for the monitoring data indicated in the storage schedule information 550 is satisfied in the remote management device 120.

In step S708, the CPU 300 acquires the monitoring data (e.g., image data) from the monitoring camera 111 (or the monitoring camera 112) based on processing by the image reception program 510.

When notification about existence of the storage monitoring data is received from the monitoring camera 111 (or the monitoring camera 112), the CPU 300 also performs the processing to acquire the storage monitoring data at an arbitrary timing.

In the present exemplary embodiment, it is assumed that the processing by the image reception program 510 constantly acquires latest image data from the monitoring camera while the storage implementation program 530 is operating. More specifically, in such a case, at least the latest image data is constantly acquired from the storage start time to the storage finish time of the storage scheduling information in the storage schedule information 550.

In step S709, the CPU 300 performs control to store the monitoring data acquired in step S708 into the storage data region 560 in the primary storage device 310 or the secondary storage device 320.

In step S710, the CPU 300 performs processing to update the storage information about the storage monitoring data existing in the storage data region 560. Then, the processing returns to step S703.

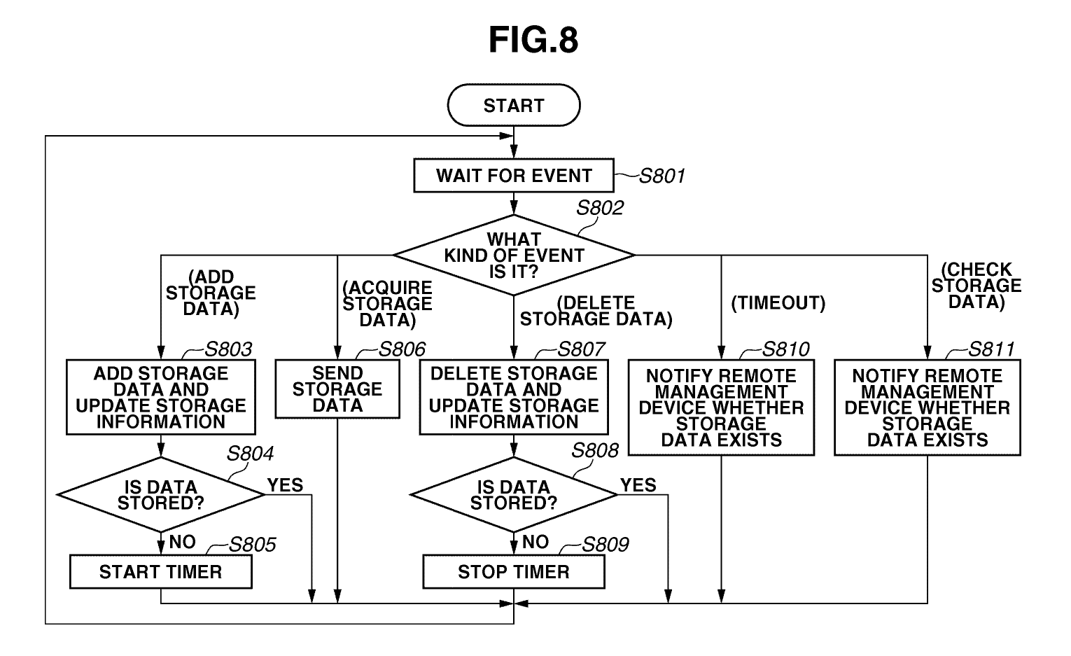

FIG. 8 is a flowchart illustrating an example of the procedure in a method for controlling the monitoring camera 111 (or the monitoring camera 112) illustrated in FIG. 1 using the storage data management program 440. The processing illustrated in FIG. 8 is performed, for example, by the CPU 200 in the monitoring camera 111 (or the monitoring camera 112) executing the storage data management program 440.

When the storage data management program 440 is started, in step S801, the CPU 200 waits until an event occurs.

When the event occurs, in step S802, the CPU 200 detects the event and determines what kind of event it is. The event detected in step S801 includes a request to add the storage monitoring data (storage data) by the storage implementation program 430, timeout by a function of the OS 400, a request to acquire, delete, or check the storage data from the remote management device 120.

As a result of determination in step S802, when the occurring event is the request to add the storage data (ADD STORAGE DATA in step S802), the processing proceeds to step S803. In step S803, when the monitoring data to be added exists, the CPU 200 adds the monitoring data into the storage data region 460, and performs processing to update the storage information.

In step S804, the CPU 200 determines whether the monitoring data is stored in the storage data region 460. As a result of the determination, if the monitoring data is stored in the storage data region 460 (YES in step S804), the timer in step S805 has already been started. Accordingly, the processing returns to step S801.

On the other hand, if the monitoring data is not stored in the storage data region 460 (NO in step S804), the processing proceeds to step S805. In step S805, the CPU 200 starts the timer for regularly notifying the remote management device 120 of the existence of the storage data (storage monitoring data) Then, the processing returns to step S801.

In step S802, when the occurring event is the request to acquire the storage data (ACQUIRE STORAGE DATA in step S802), the processing proceeds to step S806. In step S806, the CPU 200 performs processing to send the storage data (storage monitoring data) stored in the storage data region 460 to the remote management device 120. Then, the processing returns to step S801.

In step S802, when the occurring event is the request to delete the storage data (DELETE STORAGE DATA in step S802), the processing proceeds to step S807. In step S807, the CPU 200 performs processing to delete specified monitoring data from the monitoring data stored in the storage data region 460 and update the storage information.

In step S808, the CPU 200 determines whether the monitoring data stored in the storage data region 460 exists. As a result of the determination, if the monitoring data stored in the storage data region 460 exists (YES in step S808), the processing returns to step S801.

On the other hand, if the monitoring data stored in the storage data region 460 does not exist (NO in step S808), the processing proceeds to step S809. In step S809, the CPU 200 stops the above-described timer. Then, the processing returns to step S801.

In step S802, when the occurring event is the timeout of the timer (TIMEOUT in step S802), the processing proceeds to step S810. The timer is started in step S805. In step S810, the CPU 200 notifies the remote management device 120 of the contents of the current storage information, and prompts the remote management device 120 to acquire the storage data (storage monitoring data). More specifically, the CPU 200 performs processing to notify the remote management device 120 of the existence of the storage monitoring data stored in the storage device in predetermined intervals. Then, the processing returns to step S801.

In step S802, if the occurring event is the request to check the storage data (CHECK STORAGE DATA in step S802), the processing proceeds to step S811. In step S811, the CPU 200 notifies the remote management device 120 of the contents of the current storage information. More specifically, when the request to check the existence of the storage monitoring data is sent from the remote management device 120, the CPU 200 performs processing to notify the remote management device 120 of the existence of the storage monitoring data based on the storage information. Then, the processing returns to step S801.

A function of notifying of the contents of the storage information in step S810 in FIG. 8 by the timer event may not be not an essential function. However, if the function is provided, it is possible to quickly notify the remote management device 120 of the storage monitoring data after restoration of a system failure.

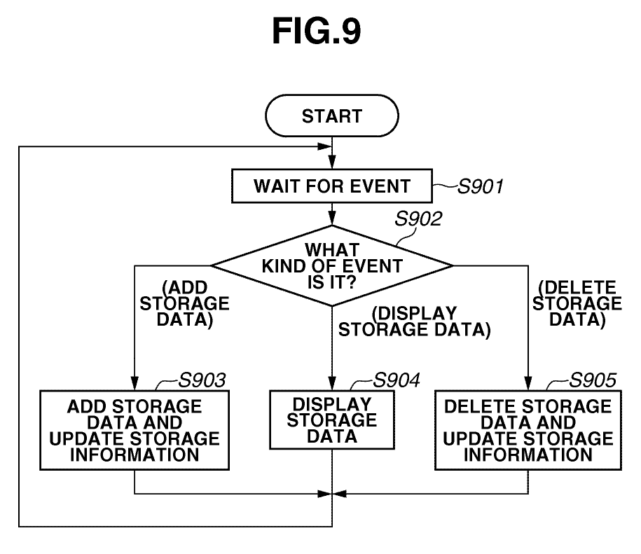

FIG. 9 is a flowchart illustrating an example of the procedure in a method for controlling the remote management device 120 illustrated in FIG. 1 using the storage data management program 540. The processing illustrated in FIG. 9 is performed, for example, by the CPU 300 in the remote management device 120 executing the storage data management program 540.

When the storage data management program 540 is started, in step S901, the CPU 300 waits until an event occurs.

When the event occurs, in step S902, the CPU 300 detects the event, and determines what kind of event it is. The event detected in step S901 includes, for example, a request to add the storage monitoring data (storage data) by the storage implementation program 530, a request to display and delete storage data sent from the user via the I/O device 350.

As a result of determination in step S902, if the occurring event is the request to add the storage data (ADD STORAGE DATA in step S902), the processing proceeds to step S903. In step S903, the CPU 300 adds the monitoring data to be added into the storage data region 560, and performs processing to update the storage information. Then, the processing returns to step S901.

In step S902, if the occurring event is the request to display the storage data (DISPLAY STORAGE DATA in step S902), the processing proceeds to step S904. In step S904, the CPU 300 reads the specified storage data (storage monitoring data) from the storage data region 560, and displays the data on a display (not shown). Then, the processing returns to step S901.

In step S902, if the occurring event is the request to delete the storage data (DELETE STORAGE DATA in step S902), the processing proceeds to step S905. In step S905, the CPU 300 performs processing to delete the storage data (storage monitoring data) stored in the storage data region 560 and update the storage information. Then, the processing returns to step S901.

More specifically, in the present exemplary embodiment, the monitoring data may be stored by the following processing.

Information (storage schedule information 450) having the same contents as the storage schedule information 550 stored in the remote management device 120 is stored in the monitoring camera. While the monitoring system 100 illustrated in FIG. 1 normally operates, the monitoring data is stored in the remote management device 120 to minimize the monitoring data to be stored in the monitoring camera. When the monitoring system 100 illustrated in FIG. 1 does not normally operate (for example, a part or a function of the remote management device 120 is stopped due to a failure or the like), the monitoring data is stored in a storage device other than the remote management device 120 according to the storage schedule information 450.

By this configuration, even if a system failure occurs, storage of the monitoring data can be ensured. Accordingly, reliability in the storage processing of the monitoring data can be increased.

A series of processing in the above-described exemplary embodiment may be implemented by hardware and software. In such a case, a program and/or computer executable instructions constituting the software may be supplied to the primary storage device or the secondary storage device from an external storage medium via a computer-readable storage medium or a network.

More specifically, each step in FIG. 6 and FIG. 8 which describes the method for controlling the monitoring camera according to the present exemplary embodiment may be implemented by executing the program and/or computer-executable instructions stored in the primary storage device 210 or the like by the CPU 200. Further, each step in FIG. 7 and FIG. 9 which describes the method for controlling the remote management device according to the present exemplary embodiment may be implemented by the CPU 300 executing the program and/or computer-executable instructions stored in the primary storage device 310 or the like. In such a case, the program and/or computer-executable instruction and the computer-readable storage medium storing the program and/or computer-executable instructions constitute an embodiment according to the present invention.

More specifically, the program and/or computer-executable instructions is supplied to a computer, for example, by storing the program in a storage medium such as a CD-ROM, or via various transmission media. As the storage medium for storing the program and/or computer-executable instructions, in addition to the CD-ROM, a flexible disk, a hard disk, a magnetic tape, a magneto-optical disk, a nonvolatile memory card, or the like may be used. As the transmission medium for the program and/or computer-executable instructions, a communication medium used in a computer network system (a LAN, a wide area network (WAN) such as the Internet, a radio communication network, or the like) for transmitting and supplying program information as a carrier wave may be used. As the communication medium, a wired line such as an optical fiber, or a wireless line may be used.

The present invention is not limited to an embodiment in which the functions of the monitoring camera and the remote management device according to the above-described exemplary embodiment of the present invention are implemented by the computer executing the supplied program and/or computer-executable instructions. The functions of the monitoring camera and the remote management device according to the above-described exemplary embodiment may be implemented by executing the program and/or computer-executable instructions in cooperation with an OS or another application software operating in the computer. In such a case, the storage medium having program and/or computer-executable instructions may constitute an embodiment according to the present invention. Further, a function expansion board or a function expansion unit in the computer may perform a part of or the whole of the processing of the supplied program and/or computer-executable instructions to implement the functions of the monitoring device and the remote management device according to the above-described exemplary embodiment. In such a case, the storage medium having the program and/or computer-executable instructions may constitute an embodiment according to the present invention.

While the present invention has been described with reference to the exemplary embodiments, it is to be understood that the invention is not limited to the disclosed exemplary embodiments. The scope of the following claims is to be accorded the broadest interpretation so as to encompass all modifications, equivalent structures and functions.

This application claims priority from Japanese Patent Application No. 2008-109503 filed on Apr. 18, 2008, which is hereby incorporated by reference herein in its entirety.

What is claimed is:

1. A monitoring apparatus that acquires at least one of image data and audio data as monitoring data, the monitoring apparatus comprising:
a reception unit configured to receive information about a storage condition of the monitoring data from a management apparatus via a network;
a detection unit configured to detect a communication state with the management apparatus; and
a control unit configured to perform control to store the monitoring data which is determined to satisfy the storage condition into a storage device that is other than the management apparatus according to the communication state detected by the detection unit.

2. The monitoring apparatus according to claim 1, wherein the reception unit receives the information about the storage condition including storage time from the management apparatus via the network.

3. The monitoring apparatus according to claim 2, wherein the control unit includes a clock unit, and stores the monitoring data according to a difference between time in the clock unit and time in the management apparatus, and storage time included in the storage condition into the storage device that is other than the management apparatus.

4. The monitoring apparatus according to claim 1, wherein the reception unit receives the information about the storage condition including at least one of object recognition, object motion detection, audio detection, and sensor output from the management apparatus via the network.

5. The monitoring apparatus according to claim 1, wherein the control unit includes the storage device that is other than the management apparatus.

6. The monitoring apparatus according to claim 1, wherein the control unit sends the monitoring data which satisfies the storage condition so that the monitoring data is stored in the storage device that is other than the management apparatus via the network.

7. The monitoring apparatus according to claim 1, wherein the control unit includes a notification unit that notifies the management apparatus of the monitoring data which satisfies the storage condition being stored in the storage device that is other than the management apparatus.

8. A method for storing at least one of image data and audio data as monitoring data, the method comprising:
transferring information about a storage condition of the monitoring data from a management apparatus to a monitoring apparatus via a network;
detecting a communication state between the management apparatus and the monitoring apparatus; and
performing control to store the monitoring data which is determined to satisfy the storage condition into a storage device that is other than the management apparatus according to the detected communication state.

9. The method according to claim 8, further comprising notifying the management apparatus of the monitoring data which satisfies the storage condition being stored in the storage device that is other than the management apparatus.

10. A storage medium storing computer-executable instructions executed by a computer which acquires at least one of image data and audio data as monitoring data, the storage medium comprising:
computer-executable instructions for receiving information about a storage condition of the monitoring data from a management apparatus via a network;
computer-executable instructions for detecting a communication state with the management apparatus; and
computer-executable instructions for performing control to store the monitoring data which is determined to satisfy the storage condition in a storage device that is other than the management apparatus according to the detected communication state.

11. The storage medium according to claim 10, wherein the storage medium further comprises computer-executable instructions for notifying the management apparatus of the monitoring data which satisfies the storage condition being stored in the storage device that is other than the management apparatus.

12. A data storage system comprising:
the monitoring apparatus and the management apparatus according to claim 1.

13. The data storage system according to claim 12, wherein the control unit includes a notification unit that notifies the management apparatus of the monitoring data which satisfies the storage condition being stored in the storage device that is other than the management apparatus.
